(19) United States
(12) Patent Application Publication
(10) Pub. No.: US 2012/0262307 A1
(43) Pub. Date: Oct. 18, 2012

(54) SYSTEMS AND METHODS FOR MONITORING CARGO CONDITIONS

(76) Inventor: TAI CHEUNG POON, Hong Kong (HK)

(21) Appl. No.: 13/088,370

(22) Filed: Apr. 17, 2011

(51) Int. Cl. G08B 23/00

(52) U.S. Cl. 340/984

(57) ABSTRACT

Cargo controllers are provided to control executions of the cargo container condition monitoring system, wherein the cargo controller is physically located inside a cargo container, wherein the cargo container is sitting on a ship, which, when cruising in midst of sea during the trip, is completely sealed and unable to allow any RF signals to pass through the cargo container; used to control a door of the cargo container, wherein the door can be open when received instructions from the cargo controller; adapted, through an antenna, to send communication signals wirelessly to send recorded information to the goods owner for reporting storage conditions of the cargo container; and used to receive measurements from cargo container condition watchers that are installed inside of the cargo controller, wherein the measurements relate to the storage conditions of the cargo container.

### FIELD OF THE INVENTION

The invention is generally related to methods and systems for monitoring cargo conditions. Specifically, and without limitation, this invention relates to monitoring storage conditions in real-time manners, to lower the risk of goods owner.

### BACKGROUND OF THE INVENTION

Conditions inside cargo containers can be humid and hot. Sometimes, the conditions are even hard to control, especially under harsh weather where a ship is navigating in the middle of the sea. Usually inside the container, humidity is much higher than most goods owner would prefer. Another challenge is that cargo container is sealed entirely. At times when the humidity or temperature is beyond a range that goods owner would prefer, goods owners would like to know instantly, in order to minimize losses. To lower risks of goods owners, some carriers are willing to guarantee the storage condition to meet a certain set of requirements. The problem is, however, that it would be very difficult for the goods owner to ensure that the carrier has fulfilled its obligation. Thus, it is obvious that the current means of way goods delivered by containers are deficient. Customers can examine goods only when the goods arrived, and the quality and conditions of the goods can never be ascertained, especially regarding the storage condition during the entire trip, which sometimes can last for months, or even years.

In view of the foregoing, better means of monitoring cargo goods are desired.

### SUMMARY OF THE INVENTION

Systems and methods are provided for monitoring cargo conditions. In one preferred embodiment, a system is provided, which comprises a cargo controller including a control processing unit and a memory unit to control executions of the cargo container condition monitoring system.

Further in the embodiment, the cargo controller may be physically located inside a cargo container. The cargo container may be sitting on a ship, which, when cruising in midst of sea during the trip, is completely sealed and unable to allow any RF signals to pass through the cargo container; used to control a door of the cargo container. The door can be open when received instructions from the cargo controller; adapted, through an antenna, to send communication signals wirelessly to send recorded information to the goods owner for reporting storage conditions of the cargo container; and used to receive measurements from cargo container condition watchers that are installed inside of the cargo controller.

The measurements may relate to the storage conditions of the cargo container; an external Cargo controller including a control processing unit and a memory unit to control executions of the cargo container condition monitoring system. The external cargo controller is physically located outside the cargo container that is sitting on the ship, which, when cruising in middle of sea during the trip, the door of the container is completely sealed, and the external cargo controller is unable to communicate with the internal cargo controller via any RF signals; used to control the door of the cargo container.

Accordance to the embodiment, the door can be open when received instructions from the external cargo controller; adapted, through the antenna, to send communication signals wirelessly to send the recorded information to the goods owner for reporting the storage conditions of the cargo container; and used to receive information from GPS receivers.

The information from the GPS receivers may include a current GPS location; a GPS receiver attached onto surface of the cargo container, wherein the GPS receiver is able to receive GPS signals even when the ship is cruising at a location, such as the middle of the sea. Most location signals may include GPRS signals would have been severely degraded or weakened; and a cargo container condition watcher installed inside the cargo controller, wherein the condition watcher is a device that is capable to serve as a sensor to monitor the storage'conditions of the cargo container.

### BRIEF DESCRIPTION OF THE DRAWINGS

FIG. 1 illustrates an exemplary system for monitoring cargo conditions.

### DETAILED DESCRIPTION

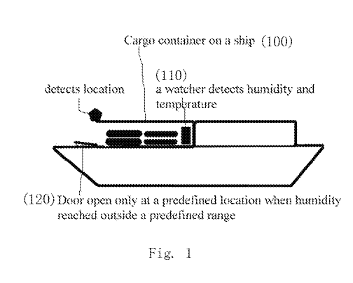

Systems and methods are provided for monitoring cargo conditions. Embodiments of the inventions may include a cargo monitoring system. Referring to the FIG. 1, the system comprises a cargo controller including a control processing unit and a memory unit to control executions of the cargo container condition monitoring system. The cargo controller is physically located inside a cargo container (100), wherein the cargo container (100) is sitting on a ship, which, when cruising in midst of sea during the trip, is completely sealed and unable to allow any RF signals to pass through the cargo container (100); used to control a door of the cargo container (120), wherein the door (120) can be open when received instructions from the cargo controller; adapted, through an antenna, to send communication signals wirelessly to send recorded information to the goods owner for reporting storage conditions of the cargo container (100); and used to receive measurements from cargo container condition watchers (110) that are installed inside of the cargo controller, wherein the measurements relate to the storage conditions of the cargo container (100); an external Cargo controller including a control processing unit and a memory unit to control executions of the cargo container condition monitoring system, wherein the external cargo controller is physically located outside the cargo container (100) that is sitting on the ship, which, when cruising in middle of sea during the trip, the door (120) of the container is completely sealed, and the external cargo controller is unable to communicate with the internal cargo controller via any RF signals; used to control the door of the cargo container (120), wherein the door (120) can be open when received instructions from the external cargo controller, adapted, through the antenna, to send communication signals wirelessly to send the recorded information to the goods owner for reporting the storage conditions of the cargo container, and used to receive information from GPS receivers, wherein the information includes a current GPS location; a GPS receiver attached onto surface of the cargo container (100), wherein the GPS receiver is able to receive GPS signals even when the ship is cruising at a location, such as the middle of the sea, where most location signals including GPRS signals would have been severely degraded or weakened; and a cargo container condition watcher (110) installed inside the cargo controller, wherein the condition watcher (110) is a device that is capable to serve as a sensor to monitor the storage conditions of the cargo container (100)

In an alternate embodiment, a cargo container condition monitoring system is disclosed. The system includes a cargo controller including a control processing unit and a memory unit to control executions of the cargo container condition monitoring system, wherein the cargo controller is physically located inside a cargo container (100), wherein the cargo container (100) is sitting on a ship, which, when cruising in midst of sea during the trip, is completely sealed and unable to allow any RF signals to pass through the cargo container (100); used to control a door (120) of the cargo container, wherein the door (120) can be open when received instructions from the cargo controller; adapted, through an antenna, to send communication signals wirelessly to send recorded information to the goods owner for reporting storage conditions of the cargo container; and used to receive measurements from cargo container condition watchers (110 that are installed inside of the cargo controller, wherein the measurements relate to the storage conditions of the cargo container; an external cargo controller including a control processing unit and a memory unit to control executions of the cargo container condition monitoring system, wherein the external cargo controller is physically located outside the cargo container that is sitting on the ship, which, when cruising in middle of sea during the trip, the door (120) of the container is completely sealed, and the external cargo controller is unable to communicate with the internal cargo controller via any RF signals; used to control the door (120) of the cargo container, wherein the door (120) can be open when received instructions from the external cargo controller; adapted, through the antenna, to send communication signals wirelessly to send the recorded information to the goods owner for reporting the storage conditions of the cargo container; and used to receive information from GPS receivers, wherein the information includes a current GPS location; a GPS receiver attached onto surface of the cargo container, wherein the GPS receiver is able to receive GPS signals even when the ship is cruising at a location, such as the middle of the sea, where most location signals including GPRS signals would have been severely degraded or weakened; and a cargo container condition watcher (110) installed inside the cargo controller, wherein the condition watcher (110) is a device that is capable to serve as a sensor to monitor the storage conditions of the cargo container, wherein the storage conditions include humidity of the storage conditions of the cargo container; and temperature of the storage conditions of the cargo container; and updated information including the storage conditions is sent to the owner only when the ship is detected at a location that is predefined by the goods owner, wherein the detection is made by the GPS receiver; when detected at the predefined location, the external cargo controller safely sends the instructions to open the door (120) of the cargo, after which the cargo container condition watcher (110), via the cargo controller, sends the updated information, in real-time, to the goods owner via the antenna for reporting the storage conditions of the cargo container.

In yet another example, the cargo controller may be physically located inside a cargo container, wherein the cargo container is sitting on a ship, which, when cruising in midst of sea during the trip, is completely sealed and unable to allow any RF signals to pass through the cargo container; used to control a door (120) of the cargo container, wherein the door (120) can be open when received instructions from the cargo controller; adapted, through an antenna, to send communication signals wirelessly to send recorded information to the goods owner for reporting storage conditions of the cargo container; and used to receive measurements from cargo container condition watchers that are installed inside of the cargo controller, wherein the measurements relate to the storage conditions of the cargo container; an external cargo controller including a control processing unit and a memory unit to control executions of the cargo container condition monitoring system, wherein the external cargo controller may be physically located outside the cargo container that is sitting on the ship, which, when cruising in middle of sea during the trip, the door of the container is completely sealed, and the external cargo controller is unable to communicate with the internal cargo controller via any RF signals; used to control the door of the cargo container, wherein the door can be open when received instructions from the external cargo controller; adapted, through the antenna, to send communication signals wirelessly to send the recorded information to the goods owner for reporting the storage conditions of the cargo container; and used to receive information from GPS receivers, wherein the information includes a current GPS location; a GPS receiver attached onto surface of the cargo container, wherein the GPS receiver is able to receive GPS signals even when the ship is cruising at a location, such as the middle of the sea, where most location signals including GPRS signals would have been severely degraded or weakened; and a cargo container condition watcher installed inside the cargo controller, wherein the condition watcher is a device that is capable to serve as a sensor to monitor the storage conditions of the cargo container, wherein the storage conditions include humidity of the storage conditions of the cargo container; and temperature of the storage conditions of the cargo container; updated information including the storage conditions is sent to the goods owner only when the temperature or the humidity has exceeded a range predefined by the goods owner, wherein the detection is made by the container condition watcher; and when exceeding the range, the cargo controller safely sends the instructions to open the door, after which the cargo container condition watcher, via the cargo controller, sends the updated information, in real-time, to the goods owner via the antenna for reporting the storage conditions of the cargo container.

In another implementation, an external cargo controller may include a control processing unit and a memory unit to control executions of the cargo container condition monitoring system, wherein the external cargo controller is physically located outside the cargo container that is sitting on the ship, which, when cruising in middle of sea during the trip, the door of the container is completely sealed, and the external cargo controller is unable to communicate with the internal cargo controller via any RF signals; used to control the door of the cargo container, wherein the door can be open when received instructions from the external cargo controller; adapted, through the antenna, to send communication signals wirelessly to send the recorded information to the goods owner for reporting the storage conditions of the cargo container; and used to receive information from GPS receivers, wherein the information includes a current GPS location; a GPS receiver attached onto surface of the cargo container, wherein the GPS receiver is able to receive GPS signals even when the ship is cruising at a location, such as the middle of the sea, where most location signals including GPRS signals would have been severely degraded or weakened; and a cargo container condition watcher installed inside the cargo controller, wherein the condition watcher is a device that is capable to serve as a sensor to monitor the storage conditions of the cargo container, wherein the storage conditions include humidity of the storage conditions of the cargo container; and temperature of the storage conditions of the cargo container; updated information including the storage conditions is sent to the goods owner when the temperature or the humidity has exceeded a range predefined by the goods owner, wherein the detection is made by the container condition watcher, and when exceeding the range, the cargo controller sends the instructions to open the door, after which the cargo container condition watcher, via the cargo controller, sends the updated information, in real-time, to the goods owner via the antenna for reporting the storage conditions of the cargo container; and the updated information including the storage conditions is sent to the owner when the ship is detected at a location that is predefined by the goods owner, wherein the detection is made by the GPS receiver.

Further in the embodiment, the external cargo controller may alternatively include a control processing unit and a memory unit to control executions of the cargo container condition monitoring system, wherein the external cargo controller is physically located outside the cargo container that is sitting on the ship, which, when cruising in middle of sea during the trip, the door of the container is completely sealed, and the external cargo controller is unable to communicate with the internal cargo controller via any RF signals; used to control the door of the cargo container, wherein the door can be open when received instructions from the external cargo controller; adapted, through the antenna, to send communication signals wirelessly to send the recorded information to the goods owner for reporting the storage conditions of the cargo container; and used to receive information from GPS receivers, wherein the information includes a current GPS location; a GPS receiver attached onto surface of the cargo container, wherein the GPS receiver is able to receive GPS signals even when the ship is cruising at a location, such as the middle of the sea, where most location signals including GPRS signals would have been severely degraded or weakened; and a cargo container condition watcher installed inside the cargo controller, wherein the condition watcher is a device that is capable to serve as a sensor to monitor the storage conditions of the cargo container, wherein the storage conditions include humidity of the storage conditions of the cargo container; and temperature of the storage conditions of the cargo container; updated information including the storage conditions is sent to the owner only when the ship is detected at a location that is predefined by the goods owner, wherein the detection is made by the GPS receiver; and the ship is stationary, as detected by the GPS receiver; and when the ship is being detected at the predefined location and the ship is being detected stationary, the external cargo controller safely sends the instructions to open the door of the cargo, after which the cargo container condition watcher, via the cargo controller, sends the updated information, in real-time, to the goods owner via the antenna for reporting the storage conditions of the cargo container. When detected at the predefined location, the external cargo controller safely sends the instructions to open the door of the cargo, after which the cargo container condition watcher, via the cargo controller, sends the updated information, in real-time, to the goods owner via the antenna for reporting the storage conditions of the cargo container.

In another aspect, the cargo controller may be physically located inside a cargo container, wherein the cargo container is sitting on a ship, which, when cruising in midst of sea during the trip, is completely sealed and unable to allow any RF signals to pass through the cargo container; used to control a door of the cargo container, wherein the door can be open when received instructions from the cargo controller; adapted, through an antenna, to send communication signals wirelessly to send recorded information to the goods owner for reporting storage conditions of the cargo container; and used to receive measurements from cargo container condition watchers that are installed inside of the cargo controller, wherein the measurements relate to the storage conditions of the cargo container; an external cargo controller including a control processing unit and a memory unit to control executions of the cargo container condition monitoring system, wherein the external cargo controller is physically located outside the cargo container that is sitting on the ship, which, when cruising in middle of sea during the trip, the door of the container is completely sealed, and the external cargo controller is unable to communicate with the internal cargo controller via any RF signals; used to control the door of the cargo container, wherein the door can be open when received instructions from the external cargo controller; adapted, through the antenna, to send communication signals wirelessly to send the recorded information to the goods owner for reporting the storage conditions of the cargo container; and used to receive information from GPS receivers, wherein the information includes a current GPS location; a GPS receiver attached onto surface of the cargo container, wherein the GPS receiver is able to receive GPS signals even when the ship is cruising at a location, such as the middle of the sea, where most location signals including GPRS signals would have been severely degraded or weakened; and a cargo container condition watcher installed inside the cargo controller, wherein the condition watcher is a device that is capable to serve as a sensor to monitor the storage conditions of the cargo container, wherein the storage conditions include humidity of the storage conditions of the cargo container; and temperature of the storage conditions of the cargo container; updated information including the storage conditions is sent to the owner only when the ship is detected at a location that is predefined by the goods owner, wherein the detection is made by the GPS receiver; and the ship is moving below a certain speed, as detected by the GPS receiver, and when the ship is being detected at the predefined location and the ship is being detected below the certain speed, the external cargo controller safely sends the instructions to open the door of the cargo, after which the cargo container condition watcher, via the cargo controller, sends the updated information, in real-time, to the goods owner via the antenna for reporting the storage conditions of the cargo container.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A cargo container condition monitoring system, comprising
a cargo controller including a control processing unit and a memory unit to control executions of the cargo container condition monitoring system.

2. The system of claim 1, wherein the cargo controller is:
physically located inside a cargo container, wherein the cargo container is sitting on a ship, which, when cruising in midst of sea during the trip, is completely sealed and unable to allow any RF signals to pass through the cargo container;
used to control a door of the cargo container, wherein the door can be open when received instructions from the cargo controller;
adapted, through an antenna, to send communication signals wirelessly to send recorded information to the goods owner for reporting storage conditions of the cargo container;
used to receive measurements from cargo container condition watchers that are installed inside of the cargo controller, wherein the measurements relate to the storage conditions of the cargo container; and the system further comprises:
an external Cargo controller including a control processing unit and a memory unit to control executions of the cargo container condition monitoring system, wherein the external cargo controller is:
physically located outside the cargo container that is sitting on the ship, which, when cruising in middle of sea during the trip, the door of the container is completely sealed, and the external cargo controller is unable to communicate with the internal cargo controller via any RF signals;
used to control the door of the cargo container, wherein the door can be open when received instructions from the external cargo controller;
adapted, through the antenna, to send communication signals wirelessly to send the recorded information to the goods owner for reporting the storage conditions of the cargo container; and
used to receive information from GPS receivers, wherein the information includes a current GPS location;
a GPS receiver attached onto surface of the cargo container, wherein the GPS receiver is able to receive GPS signals even when the ship is cruising at a location, such as the middle of the sea, where most location signals including GPRS signals would have been severely degraded or weakened; and
a cargo container condition watcher installed inside the cargo controller, wherein the condition watcher is a device that is capable to serve as a sensor to monitor the storage conditions of the cargo container.

3. The system of claim 1, wherein the cargo controller is:
physically located inside a cargo container, wherein the cargo container is sitting on a ship, which, when cruising in midst of sea during the trip, is completely sealed and unable to allow any RF signals to pass through the cargo container;
used to control a door of the cargo container, wherein the door can be open when received instructions from the cargo controller;
adapted, through an antenna, to send communication signals wirelessly to send recorded information to the goods owner for reporting storage conditions of the cargo container;
used to receive measurements from cargo container condition watchers that are installed inside of the cargo controller, wherein the measurements relate to the storage conditions of the cargo container; and the system further comprises:
an external cargo controller including a control processing unit and a memory unit to control executions of the cargo container condition monitoring system, wherein the external cargo controller is:
physically located outside the cargo container that is sitting on the ship, which, when cruising in middle of sea during the trip, the door of the container is completely sealed, and the external cargo controller is unable to communicate with the internal cargo controller via any RF signals;
used to control the door of the cargo container, wherein the door can be open when received instructions from the external cargo controller;
adapted, through the antenna, to send communication signals wirelessly to send the recorded information to the goods owner for reporting the storage conditions of the cargo container; and
used to receive information from GPS receivers, wherein the information includes a current GPS location;
a GPS receiver attached onto surface of the cargo container, wherein the GPS receiver is able to receive GPS signals even when the ship is cruising at a location, such as the middle of the sea, where most location signals including GPRS signals would have been severely degraded or weakened; and
a cargo container condition watcher installed inside the cargo controller, wherein the condition watcher is a device that is capable to serve as a sensor to monitor the storage conditions of the cargo container, wherein:
the storage conditions include:
humidity of the storage conditions of the cargo container; and
temperature of the storage conditions of the cargo container; and
updated information including the storage conditions is sent to the owner only when the ship is detected at a location that is predefined by the goods owner, wherein the detection is made by the GPS receiver;
when detected at the predefined location, the external cargo controller safely sends the instructions to open the door of the cargo, after which the cargo container condition watcher, via the cargo controller, sends the updated information, in real-time, to the goods owner via the antenna for reporting the storage conditions of the cargo container.

4. The system of claim 1, wherein the cargo controller is:
physically located inside a cargo container, wherein the cargo container is sitting on a ship, which, when cruising in midst of sea during the trip, is completely sealed and unable to allow any RF signals to pass through the cargo container;
used to control a door of the cargo container, wherein the door can be open when received instructions from the cargo controller;
adapted, through an antenna, to send communication signals wirelessly to send recorded information to the goods owner for reporting storage conditions of the cargo container;
used to receive measurements from cargo container condition watchers that are installed inside of the cargo controller, wherein
the measurements relate to the storage conditions of the cargo container, and the system further comprises:
an external cargo controller including a control processing unit and a memory unit to control executions of the cargo container condition monitoring system, wherein the external cargo controller is:
physically located outside the cargo container that is sitting on the ship, which, when cruising in middle of sea during the trip, the door of the container is completely sealed, and the external cargo controller is unable to communicate with the internal cargo controller via any RF signals;
used to control the door of the cargo container, wherein the door can be open when received instructions from the external cargo controller;
adapted, through the antenna, to send communication signals wirelessly to send the recorded information to the goods owner for reporting the storage conditions of the cargo container; and
used to receive information from GPS receivers, wherein the information includes a current GPS location;
a GPS receiver attached onto surface of the cargo container, wherein the GPS receiver is able to receive GPS signals even when the ship is cruising at a location, such as the middle of the sea, where most location signals including GPRS signals would have been severely degraded or weakened; and
a cargo container condition watcher installed inside the cargo controller, wherein the condition watcher is a device that is capable to serve as a sensor to monitor the storage conditions of the cargo container, wherein:
the storage conditions include:
humidity of the storage conditions of the cargo container; and
temperature of the storage conditions of the cargo container;
updated information including the storage conditions is sent to the goods owner only when the temperature or the humidity has exceeded a range predefined by the goods owner, wherein the detection is made by the container condition watcher; and
when exceeding the range, the cargo controller safely sends the instructions to open the door, after which the cargo container condition watcher, via the cargo controller, sends the updated information, in real-time, to the goods owner via the antenna for reporting the storage conditions of the cargo container.

5. The system of claim 1, wherein the cargo controller is:
physically located inside a cargo container, wherein the cargo container is sitting on a ship, which, when cruising in midst of sea during the trip, is completely sealed and unable to allow any RF signals to pass through the cargo container;
used to control a door of the cargo container, wherein the door can be open when received instructions from the cargo controller;
adapted, through an antenna, to send communication signals wirelessly to send recorded information to the goods owner for reporting storage conditions of the cargo container;
used to receive measurements from cargo container condition watchers that are installed inside of the cargo controller, wherein the measurements relate to the storage conditions of the cargo container; and the system further comprises:
an external cargo controller including a control processing unit and a memory unit to control executions of the cargo container condition monitoring system, wherein the external cargo controller is:
physically located outside the cargo container that is sitting on the ship, which, when cruising in middle of sea during the trip, the door of the container is completely sealed, and the external cargo controller is unable to communicate with the internal cargo controller via any RF signals;
used to control the door of the cargo container, wherein the door can be open when received instructions from the external cargo controller;
adapted, through the antenna, to send communication signals wirelessly to send the recorded information to the goods owner for reporting the storage conditions of the cargo container; and
used to receive information from GPS receivers, wherein the information includes a current GPS location;
a GPS receiver attached onto surface of the cargo container, wherein the GPS receiver is able to receive GPS signals even when the ship is cruising at a location, such as the middle of the sea, where most location signals including GPRS signals would have been severely degraded or weakened; and
a cargo container condition watcher installed inside the cargo controller, wherein the condition watcher is a device that is capable to serve as a sensor to monitor the storage conditions of the cargo container, wherein:
the storage conditions include:
humidity of the storage conditions of the cargo container; and
temperature of the storage conditions of the cargo container;
updated information including the storage conditions is sent to the goods owner when the temperature or the humidity has exceeded a range predefined by the goods owner, wherein the detection is made by the container condition watcher; and
when exceeding the range, the cargo controller sends the instructions to open the door, after which the cargo container condition watcher, via the cargo controller, sends the updated information, in real-time, to the goods owner via the antenna for reporting the storage conditions of the cargo container; and
the updated information including the storage conditions is sent to the owner when the ship is detected at a location that is predefined by the goods owner, wherein the detection is made by the GPS receiver;
when detected at the predefined location, the external cargo controller safely sends the instructions to open the door of the cargo, after which the cargo container condition watcher, via the cargo controller, sends the updated information, in real-time, to the goods owner via the antenna for reporting the storage conditions of the cargo container.

6. The system of claim 1, wherein the cargo controller is:
physically located inside a cargo container, wherein the cargo container is sitting on a ship, which, when cruising in midst of sea during the trip, is completely sealed and unable to allow any RF signals to pass through the cargo container;
used to control a door of the cargo container, wherein the door can be open when received instructions from the cargo controller;
adapted, through an antenna, to send communication signals wirelessly to send recorded information to the goods owner for reporting storage conditions of the cargo container;
used to receive measurements from cargo container condition watchers that are installed inside of the cargo controller, wherein the measurements relate to the storage conditions of the cargo container; and the system further comprises:
an external cargo controller including a control processing unit and a memory unit to control executions of the cargo container condition monitoring system, wherein the external cargo controller is:
physically located outside the cargo container that is sitting on the ship, which, when cruising in middle of sea during the trip, the door of the container is completely sealed, and the external cargo controller is unable to communicate with the internal cargo controller via any RF signals;
used to control the door of the cargo container, wherein the door can be open when received instructions from the external cargo controller;
adapted, through the antenna, to send communication signals wirelessly to send the recorded information to the goods owner for reporting the storage conditions of the cargo container; and
used to receive information from GPS receivers, wherein the information includes a current GPS location;
a GPS receiver attached onto surface of the cargo container, wherein the GPS receiver is able to receive GPS signals even when the ship is cruising at a location, such as the middle of the sea, where most location signals including GPRS signals would have been severely degraded or weakened; and
a cargo container condition watcher installed inside the cargo controller, wherein the condition watcher is a device that is capable to serve as a sensor to monitor the storage conditions of the cargo container, wherein:
the storage conditions include:
humidity of the storage conditions of the cargo container; and
temperature of the storage conditions of the cargo container;
updated information including the storage conditions is sent to the owner only when:
the ship is detected at a location that is predefined by the goods owner, wherein the detection is made by the GPS receiver; and
the ship is stationary, as detected by the GPS receiver; and
when the ship is being detected at the predefined location and the ship is being detected stationary, the external cargo controller safely sends the instructions to open the door of the cargo, after which the cargo container condition watcher, via the cargo controller, sends the updated information, in real-time, to the goods owner via the antenna for reporting the storage conditions of the cargo container.

7. The system of claim 1, wherein the cargo controller is:
physically located inside a cargo container, wherein the cargo container is sitting on a ship, which, when cruising in midst of sea during the trip, is completely sealed and unable to allow any RF signals to pass through the cargo container;
used to control a door of the cargo container, wherein the door can be open when received instructions from the cargo controller;
adapted, through an antenna, to send communication signals wirelessly to send recorded information to the goods owner for reporting storage conditions of the cargo container;
used to receive measurements from cargo container condition watchers that are installed inside of the cargo controller, wherein the measurements relate to the storage conditions of the cargo container; and the system further comprises:
an external cargo controller including a control processing unit and a memory unit to control executions of the cargo container condition monitoring system, wherein the external cargo controller is:
physically located outside the cargo container that is sitting on the ship, which, when cruising in middle of sea during the trip, the door of the container is completely sealed, and the external cargo controller is unable to communicate with the internal cargo controller via any RF signals;
used to control the door of the cargo container, wherein the door can be open when received instructions from the external cargo controller;
adapted, through the antenna, to send communication signals wirelessly to send the recorded information to the goods owner for reporting the storage conditions of the cargo container; and
used to receive information from GPS receivers, wherein the information includes a current GPS location;
a GPS receiver attached onto surface of the cargo container, wherein the GPS receiver is able to receive GPS signals even when the ship is cruising at a location, such as the middle of the sea, where most location signals including GPRS signals would have been severely degraded or weakened; and
a cargo container condition watcher installed inside the cargo controller, wherein the condition watcher is a device that is capable to serve as a sensor to monitor the storage conditions of the cargo container, wherein:
the storage conditions include:
humidity of the storage conditions of the cargo container; and
temperature of the storage conditions of the cargo container;
updated information including the storage conditions is sent to the owner only when:
the ship is detected at a location that is predefined by the goods owner, wherein the detection is made by the GPS receiver; and
the ship is moving below a certain speed, as detected by the GPS receiver; and
when the ship is being detected at the predefined location and the ship is being detected below the certain speed, the external cargo controller safely sends the instructions to open the door of the cargo, after which the cargo container condition watcher, via the cargo controller, sends the updated information, in real-time, to the goods owner via the antenna for reporting the storage conditions of the cargo container.
